(19) United States
(12) Patent Application Publication
(10) Pub. No.: US 2010/0302189 A1
(43) Pub. Date: Dec. 2, 2010

(54) PEN STROKE TRACK UPDATING METHOD AND SYSTEM THEREOF FOR HANDHELD TOUCH DEVICE

(75) Inventor: Chi-Shen Liu, Taoyuan City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HTC Corporation, Taoyuan City (TW)

(21) Appl. No.: 12/788,465

(22) Filed: May 27, 2010

(30) Foreign Application Priority Data
May 27, 2009 (TW) 098117683

(51) Int. Cl. G06F 3/041

(52) U.S. Cl. 345/173

(57) ABSTRACT

A pen stroke track updating method and system thereof for handheld touch device are provided. In the method, the user firstly touches the touch module to form a pen stroke track using his finger, whereupon a control unit matches the pen stroke track with a plurality of track paths prestored in a storage module, determines whether or not the pen stroke track matches track removal rules, or determines whether or not the pen stroke track has been overlapped, and then a partial track, or the entire pen stroke track is removed according to the result of matching or analysis. Afterward, when the finger has left the touch module, the recorded pen stroke track is designated as a stopped track, which is used as a matching condition to obtain the required track path.

### CROSS-REFERENCE TO RELATED APPLICATION

This application claims the benefit of Taiwan Patent Application No. 098117683, filed on May 27, 2009, which is hereby incorporated by reference for all purposes as if fully set forth herein.

### BACKGROUND OF THE INVENTION

1. Field of Invention

A pen stroke track input method and system thereof for handheld touch device are provided, and more particularly to a pen stroke track updating method and system thereof for handheld touch device which enables momentarily correction of pen stroke tracks.

2. Related Art

Referring to FIG. 1A, which depicts a handheld touch device of the prior art, in which a handheld touch device 10 is provided with a touch module 11 that is used to detect touched positions to form a pen stroke track 12, whereupon, according to the pen stroke track 12, the corresponding control instruction is executed.

As depicted in FIG. 1A, when processing words or graphics, the finger or touch control pen is used to upwardly slide on the touch module 11 to produce the straight upward pen stroke track 12, whereupon the handheld touch device 10 causes upward turning of a page.

Referring also to FIG. 1B, when browsing web pages, the finger is used to slide over the touch module 11 in a clockwise direction to produce the clockwise, arc-shaped pen stroke track 12, whereupon the handheld touch device 10 returns to displaying the previously browsed webpage according to the arc-shaped pen stroke track 12, or the finger is used to slide over the touch module 11 in an anti-clockwise direction to produce the counter clockwise, arch-shaped pen stroke track 12, whereupon the handheld touch device 10 goes on to display the next webpage for browsing according to the arc-shaped pen stroke track 12,

However, the prior art has unavoidable shortcomings, including, when the user realizes that he has erroneously drawn a pen stroke track, he cannot immediately correct the pen stroke track when his finger is paused on the touch module. The user must take his finger from the touch module to execute the corresponding control instruction to correct the erroneous pen stroke track, and then cancel the control instruction execution operation, or activate a related function to instruct the handheld touch device to return to the operation state prior to executing the control instruction, which senselessly increases usage time, thus, careful consideration needs to be given to questions of practicability.

Secondly, if a control instruction cannot be canceled once executed, there is the extreme likelihood of causing the user or respective company needless trouble, such as when the user is processing important client emails, and the user wants to remove erroneous email content, but executes the wrong control instruction and sends the erroneous email, thereby very likely causing the client needless misunderstandings because of the erroneous email. What is more, there is the extreme possibility of confidential documents of the company or individual privacy being leaked out, thereby damaging the reputation of the company or individual.

### SUMMARY OF THE INVENTION

In light of the above, the problems to be resolved by the present disclosure lies in providing a pen stroke track input method and system thereof that enables momentarily correcting user input without taking the finger away from a touch module.

In order to resolve the problems of the aforementioned methods, the technical means provided by the present disclosure discloses a pen stroke track updating method for handheld touch device, in which the touched positions on a touch panel of a handheld touch device are first recorded to continually form a pen stroke track, then the pen stroke track is compared with track paths prestored in the handheld touch device, and the pen stroke track is updated, or removed according to the result of match the pen stroke track with the track paths. After which, when it is determined that the touch module is no longer being touched, the recorded pen stroke track is designated as a stopped track, and the stopped track is compared with the track paths to obtain the best matching track path.

In order to resolve the problems of the aforementioned methods, the technical means provided by the present disclosure discloses another pen stroke track updating method for handheld touch device, in which the touched positions on a touch module of a handheld touch device are first recorded to continually form a pen stroke track, then it is determined whether or not formation of the pen stroke track matches track removal rules, and the pen stroke track is updated, or a partial track of the pen stroke track is removed according to the comparative result. After which, when it is determined that the touch module is no longer being touched, the recorded pen stroke track is designated as a stopped track, and the stopped track is compared with the track paths to obtain the best matching track path.

In the pen stroke track input updating methods for handheld touch device disclosed by the present disclosure, the path track removal rules comprise three kinds: one, when it is determined that the end point of the pen stroke track overlaps any position of the pen stroke track, the track between the overlapping position to the end point is designated as the aforementioned partial track, and the overlapping position is set as the end point after removing the partial track; two, set error areas for the pen stroke track, and when it is determined that the error area adjoining the end point has been touched, the touched position of the error area is analyzed to calculate the partial track that needs to be removed; three, when it is determined that the end point of the pen stroke track overlaps an adjoining track of the pen stroke track, the track between the overlapping position to the end point is designated as the aforementioned partial track, and the overlapping position is set as the end point after removing the partial track.

In order to resolve the aforementioned system problems, the technical means provided by the present disclosure discloses a pen stroke track updating system for handheld touch device, comprising a storage module, a touch module and a control unit. The storage module is used to store a plurality of track paths, and the touch module is used to enable touching and recording the touched positions to continually form a pen stroke track. The control unit is used to determine whether or not the pen stroke track matches at least one of the track paths, and when a match is found, the pen stroke track is updated, or when no match is found, the pen stroke track is removed. When it is determined that the touch module is still being touched, the pen stroke track continues to be formed.

In order to resolve the aforementioned system problems, the technical means provided by the present disclosure discloses another pen stroke track updating system for handheld touch device, comprising a storage module, a touch module and a control unit. The storage module is used to store track removal rules, and the touch module is used to enable touching and recording the touched positions to continually form a pen stroke track. The control unit is used to determine whether or not formation of the pen stroke track matches the track removal rules, and when a match is found, a partial track of the pen stroke track is removed according to the track removal rules, whereupon the touch module carries out an error correction on the current touched position and the end point of the pen stroke track, or when no match is found, the pen stroke track is updated. When it is determined that the touch module is still being touched, the pen stroke track continues to be formed. The present disclosure is provided with efficacy heretofore unachievable in the prior art, including:

One, in a situation whereby the user continues to touch the touch module, the pen stroke track updating method disclosed by the present disclosure enables the user to update, correct erroneous pen stroke tracks, thus, the handheld touch device obtains the correct pen stroke track required by the user after the finger of the user is taken away from the touch module, thereby enabling matching with an internally stored track path, and execution of the required control instruction.

Two, regardless of what kind of erroneous pen stroke track is first inputted, through use of the pen stroke track updating method disclosed by the present disclosure, the user is able to momentarily correct the pen stroke track, thereby enabling the correct pen stroke track to be produced through a single input, thus, reducing the number of times control instructions are erroneously input, which further improves applicability of the handheld touch device.

To enable a further understanding of said objectives and the technological methods of the disclosure herein, a brief description of the drawings is provided below followed by a detailed description of the preferred examples.

### BRIEF DESCRIPTION OF THE DRAWINGS

The present disclosure will become more fully understood from the detailed description given herein below for illustration only, and thus are not limitative of the present disclosure, and wherein:

FIG. 1A and FIG. 1B are schematic views depicting pen stroke tracks of the prior art.

FIG. 2 is a block schematic view of one example of a handheld touch device of the present disclosure.

FIG. 3A is a schematic view of an example of the handheld touch device of the present disclosure.

FIG. 3B is a schematic flow chart depicting pen stroke track updating according to a first example of the present disclosure.

FIG. 3C is a drawing comparing a pen stroke track and a track path according to the first example of the present disclosure.

FIG. 3D is a schematic view depicting all track paths of the example according to the present disclosure.

FIG. 3E is a schematic view depicting track paths being displayed when the handheld touch device is being touched according to the example of the present disclosure.

FIG. 4A is a drawing depicting failure to match the pen stroke track according to the first example of the present disclosure.

FIG. 4B is a schematic view depicting removal of the pen stroke track according to first example of the present disclosure.

FIG. 5 is a block schematic view of another example of the handheld touch device of the present disclosure.

FIG. 6A is a schematic flow chart of a second example for updating the pen stroke track according to the present disclosure.

FIG. 6B is a first track removal rule flow chart according to the second example of the present disclosure.

FIG. 6C is a schematic view depicting a pen stroke track according to the second example of the present disclosure.

FIG. 6D is a schematic view of error touch areas according to the second example of the present disclosure.

FIG. 6E is a schematic view depicting partial track removal according to the second example of the present disclosure.

FIG. 6F is a second track removal rule flow chart according to the second example of the present disclosure.

FIG. 6G is a schematic view depicting track overlap according to the second example of the present disclosure.

FIG. 6H is a schematic view depicting partial track removal according to the second example of the present disclosure.

FIG. 6I is schematic flow chart of a third example for updating the pen stroke track according to the present disclosure.

FIG. 6J is a schematic view depicting a pen stroke track according to the third example of the present disclosure.

FIG. 6K is a schematic view depicting track overlap according to the third example of the present disclosure.

FIG. 6L is a schematic view depicting partial track removal according to the third example of the present disclosure.

FIG. 7A is a schematic view track depicting track retention according to the second example of the present disclosure.

FIG. 7B is a schematic view depicting pen stroke track updating according to the second example of the present disclosure.

FIG. 8 is a matching view of a pen stroke track and track path according to an example of the present disclosure.

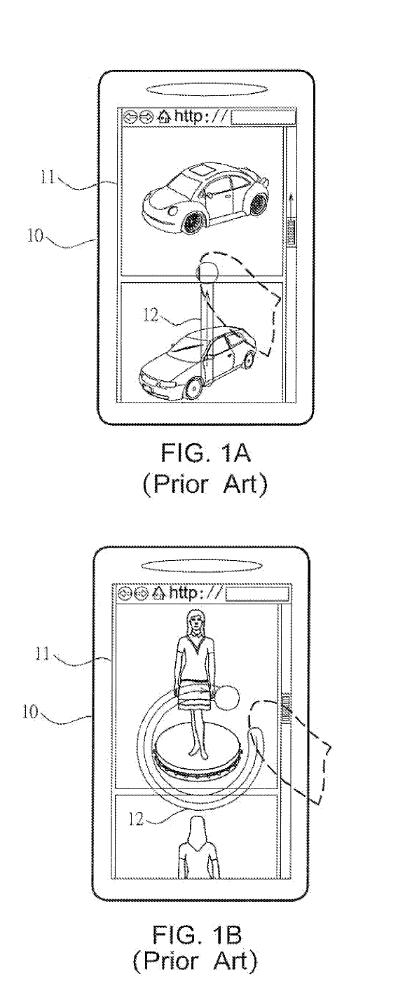

### DETAILED DESCRIPTION OF THE INVENTION

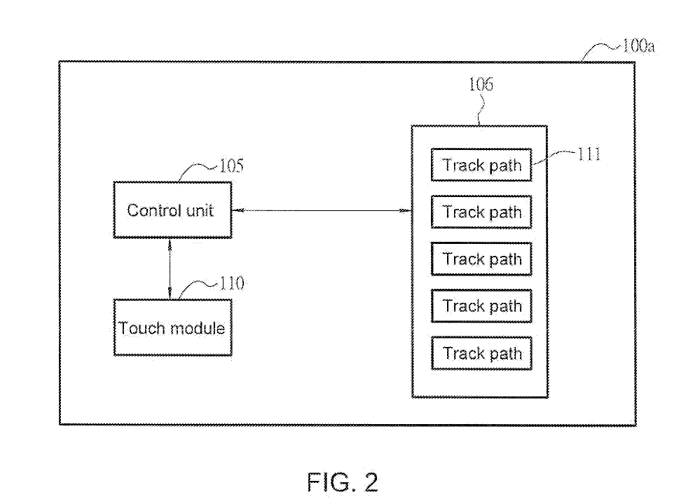

Referring to FIG. 2, which shows a block schematic view of an example of a handheld touch device of the present disclosure, in which a handheld touch device 100a comprises a storage module 106, a touch module 110 and a control unit 105.

The storage module 106 stores more than one track path 111, and the control unit 105 is separately electrically coupled to the touch module 110 and the storage module 106. The touch module 110 is used to enable the user to touch the touch module 110 by fingers, a touch control pen, and related objects and record the touched positions to continually form a pen stroke track 120.

The control unit 105 obtains the pen stroke track 120 recorded by the touch module 110, and matches the pen stroke track 120 with prestored track paths of the storage module 106 to determine whether or not it matches at least one of the track paths. If a match is determined, the control unit 105 does not act, and allows the touch module 110 to continue to update the pen stroke track 120. If a match is not determined, the control unit 105 removes the pen stroke track 120 recorded by the touch module 110.

In addition, the touch module 110 can be a touch screen, which displays the recorded pen stroke track. Moreover the control unit 105 can instruct the touch module 110 display the track path 111 matching the pen stroke track, thereby enabling the user to know the instruction corresponding to the current inputted pen stroke track. Furthermore, when the control unit 105 determines that the touch module 110 is being touched, the control unit 105 can instruct the touch module 110 to display all the prestored track paths 111 of the storage module 106, for reference by the user.

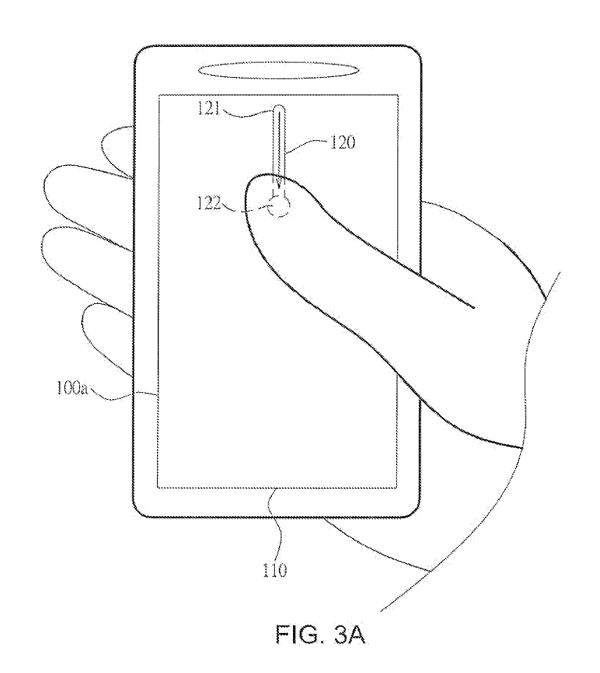

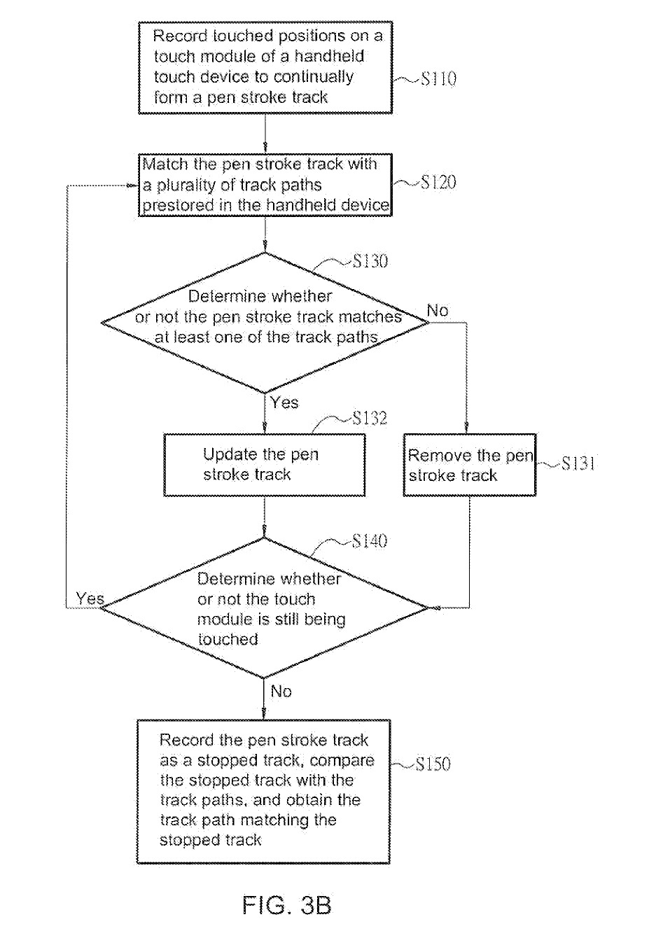

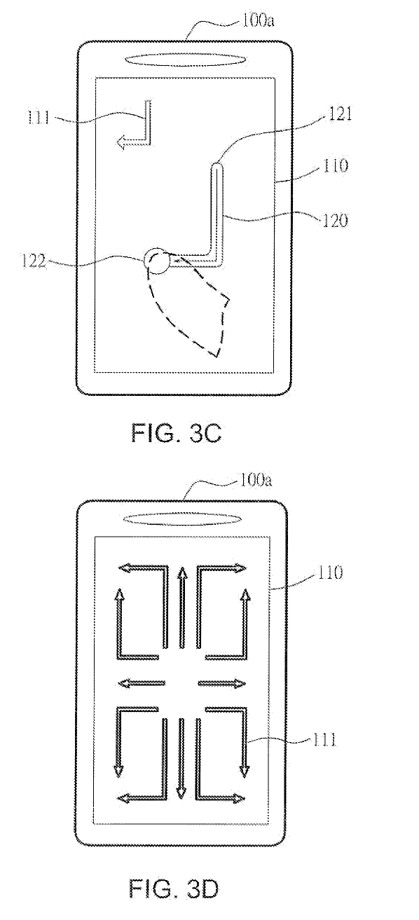

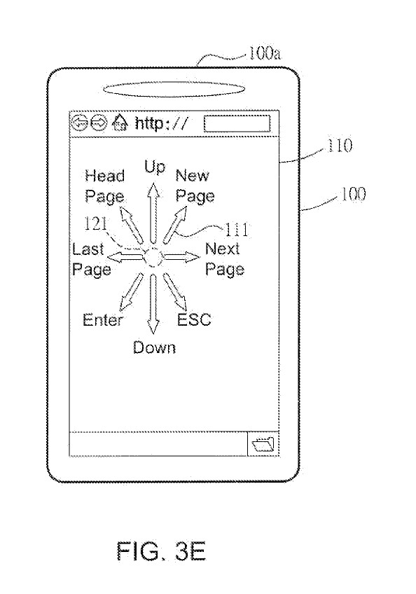

Referring to FIG. 3A, which shows a schematic view of the example depicting a user holding the handheld touch device 100a of the present disclosure, and at the same time referring to FIG. 2 to facilitate understanding, from FIG. 3A it can be known that the user is able to single-handedly hold the handheld touch device 100a while touching and sliding on the touch module 110 of the handheld control device 100a using the thumb to draw the required pen stroke track 120. Accordingly, all operations of the user can be single-handedly completed. It is understood that the user can also hold the handheld touch device 100a and touch and slide on the touch module 110 using the other hand to draw the pen stroke track 120.

Referring to FIG. 3B, which shows an schematic flow chart depicting updating of the pen stroke track 120 according to a first example of the present disclosure, the method comprising the following steps:

It is recorded the touched positions on the touch module 110 of the handheld touch device 100a to continually form a pen stroke track 120 (step S110). Referring to FIG. 3C, when the touch module 110 of the handheld touch device 100a is touched by a finger of the user, the first touched position is designated as a starting point 121, and the current position touched by the finger is designated as an end point 122, and all positions continually touched on the touch module 110 between the starting point 121 and the end point 122 are recorded, thereby forming the continuous pen stroke track 120. The pen stroke track 120 is displayed on the touch module 110 and presents a line with specific width.

It is matched the pen stroke track 120 with a plurality of the prestored track paths 111 in the handheld touch device 100a (step S120). Referring to FIG. 3D, which shows all the track paths 111 prestored within the handheld touch device 100a, and the directions of the track paths 111 include: up, down, left, right, up-left, up-right, down-left, down-right, left-up, left-down, right-up, and right-down, but are not limited to these directions, and can also include directions such as left-diagonal-up, left-diagonal-down, right-diagonal-up and right-diagonal-down. Because the track paths 111 have application in the handheld touch device 100a, thus, using them for line comparison is very simple, enabling companies to prestore the needed track paths 111 according to different functions required. Apart from the aforementioned directions, the track paths 111 can also be additionally configured with clockwise and counter-clockwise directions.

As depicted in FIG. 3C, when a user slides across the touch module 110, and the pen stroke track 120 drawn is a down-left direction, then the control unit 105 carries out a comparison with the directions of all the track paths 111 according to the starting point 121 of the pen stroke track 120, the current end point 122, along with the slide direction and formed line. Accordingly, when the pen stroke track 120 is a down stroke, the control unit 105 compares the stroke with one of the matching track paths 111, including down, down-left and down-right. When the pen stroke track 120 turns ‘left’, the control unit 105 matches the stroke with the matching track path 111 ‘down-left’, In order to ensure the user inputs the correct pen stroke track 120, the control unit 105 is able to display the track path 111 matching the pen stroke track 120 on the touch module 110.

Referring to FIG. 3E, the touch module 110 can be a touch screen, wherein when the control unit 105 determines that the touch module 110 is being touched, the touch module 110 displays all track paths for reference by the user.

It is determined whether or not the pen stroke track 120 matches at least one of the track paths 111 (step S130), whereby the control unit 105 determines whether or not the pen stroke track 120 input by the user is acceptable for the handheld touch device 100a.

If a match is determined, the control unit 105 instructs the touch module 110 to retain the previously recorded touched positions, and to continue updating the pen stroke track 120 (step S132), as depicted in FIG. 3C.

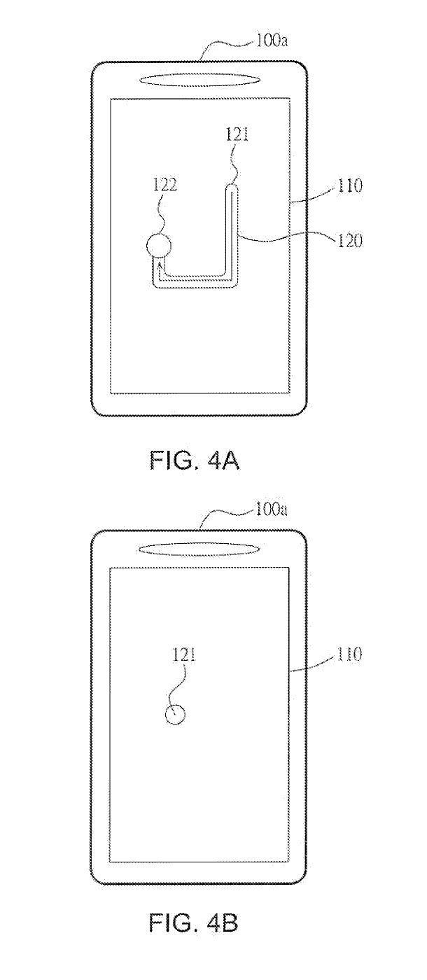

If no match is determined, the pen stroke track 120 is removed (step S131). Referring to FIG. 4A, in which the pen stroke track 120 drawn by the user does not match with the track paths 111, thus, the control unit 105 removes the pen stroke track 120 recorded by the touch module 110, as depicted in FIG. 4B, and takes the current position touched by the finger as the starting point 121 of the pen stroke track 120 to enable drawing of the pen stroke track 120 to be continued.

Afterward, the control unit 105 determines whether or not the touch module 110 is still being touched (step S140). If it is determined that the touch module 110 continues to be touched, step S120 is returned to, to continue matching the pen stroke track 120 with the track paths 111. On the contrary, if it is determined that the touch module 110 is not being touched, that is, the finger of the user has moved away from the touch module 110, then the current recorded pen stroke track 120 is taken as that required, The control unit 105 records the pen stroke track 120 as a stopped path, and the stopped path is compared with all the track paths 111 to obtain the track path 111 matching the stopped path (step S150).

In addition, the handheld touch device 100a is able to execute the related control instruction according to the track path 111 matching the stopped track. For example, the up, down scrolling function of a document editing program, the forward, backward page turning function of a website browser, or the playing, sound recording, song selection function of a media player; as well as shortcut instructions for logging out, shutting down, or presetting of the built-in system function module of the operating system of the handheld touch control device 100a.

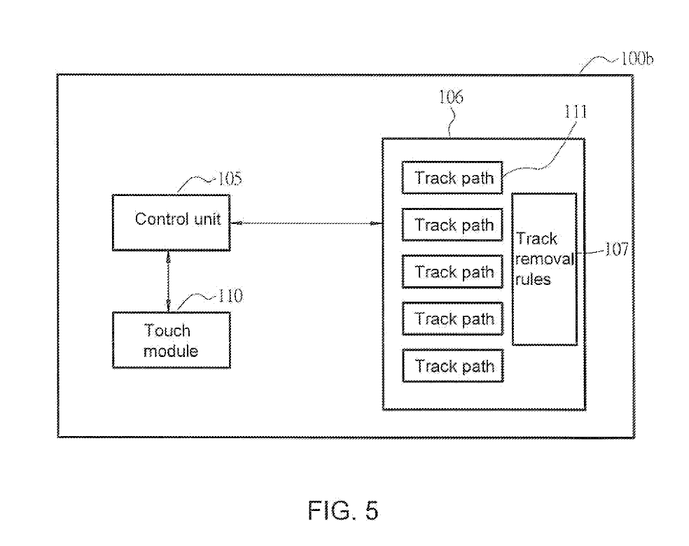

Referring to FIG. 5, which shows a block schematic view of another example of the handheld touch device of the present disclosure, in which a handheld touch device 100b comprises the storage module 106, the touch module 110 and the control unit 105. The storage module 106 stores track removal rules 107, and the control unit 105 is separately electrically coupled to the control module 110 and the storage module 106.

The touch module 110 is used to record the touched portions touched by a user using his finger, a touch pen, and other related objects and continually form the pen stroke track 120.

The control unit 105 obtains the pen stroke track 120 recorded by the touch module 110 and determines whether or not formation of the pen stroke track 120 matches the track removal rules 107. If it is determined that no match is found, the control unit 105 does not act, thereby causing the touch module 110 to continue to update the pen stroke track 120. If it is determined that a match is found, the pen stroke track 120 is removed according to the track removal rules 107, and the touch module 110 carries out an error correction on the current touched position and the end point of the pen stroke track 120.

In addition, the touch module 110 can be a touch screen, which displays the recorded pen stroke track 120. Moreover, the storage module 106 can prestore a plurality of the track paths 111, and the control unit 105 can instruct the touch module 110 to display the track paths 111 matching the pen stroke track 120, thereby enabling the user to know the instruction corresponding to the current inputted pen stroke track. Furthermore, when the control unit 105 determines that the touch module 110 is being touched, the control unit 105 is able to instruct the touch module 110 to display all the track paths 111 prestored in the storage module 106 for reference by the user.

The path track removal rules 107 comprise three kinds of decision models: one, make the range of a specific width of two sides of the vertical pen stroke track to be the error areas of the pen stroke track 120, accordingly, when the control unit 105 determines that the error area adjoining the end point of the pen stroke track 120 is being touched, formation of the pen stroke track 120 matches the track removal rules 107, and the control unit 105 analyzes the position of the error area touched to calculate the partial track that needs to be removed; two, when the end point of the pen stroke track 120 overlaps any position in the pen stroke track 120, formation of the pen stroke track 120 matches the track removal rules 107, and the control unit 105 designates the track between the overlapping position to the end point of the pen stroke track 120 to be a partial track, and sets the overlapping position to be the end point of the pen stroke track 120 after removing the partial track; three, when the end point of the pen stroke track 120 overlaps the pen stroke track, formation of the pen stroke track 120 matches the track removal rules 107, and the control unit 105 removes the overlapping path of the pen stroke track 120, and sets the end point of the pen stroke track 120 after removing the overlapping path.

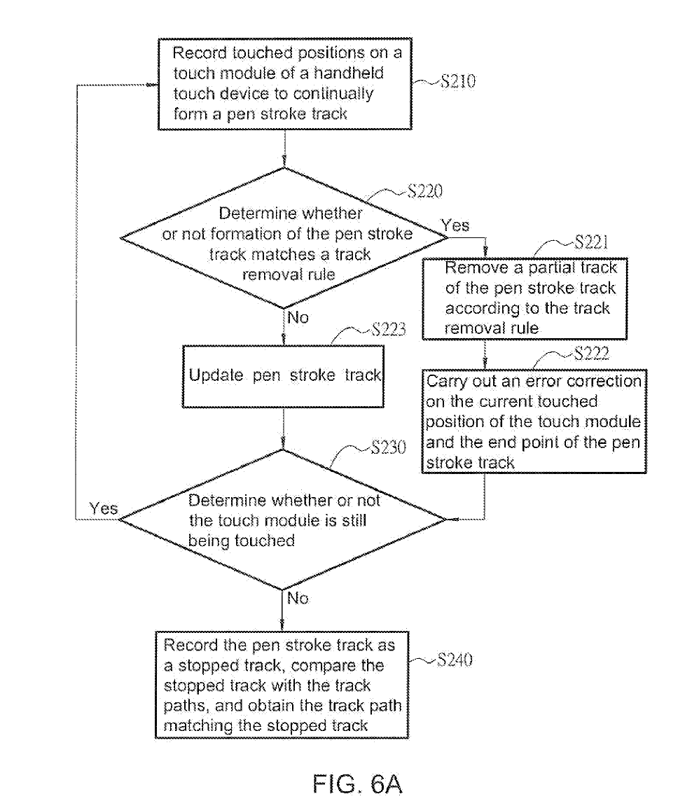

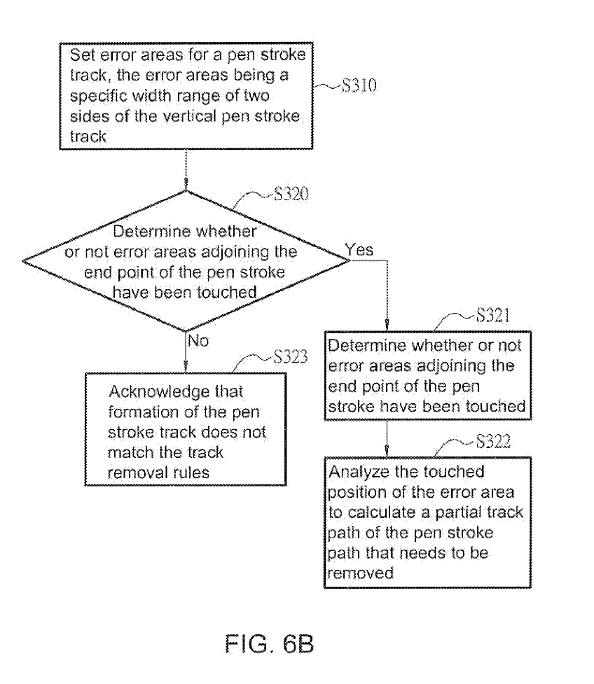

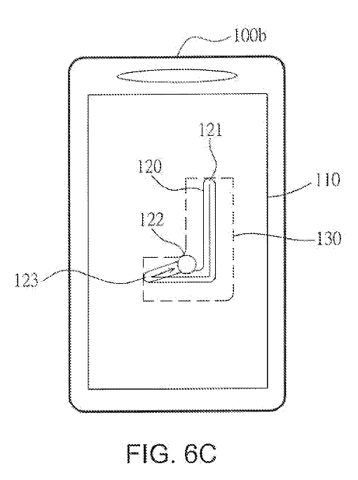

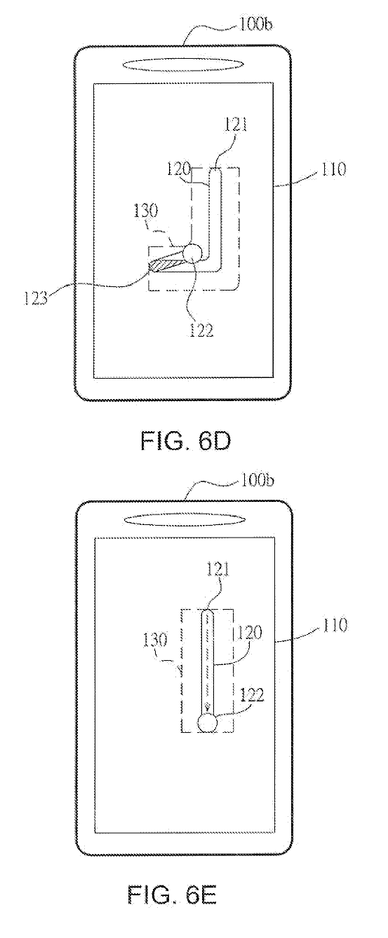

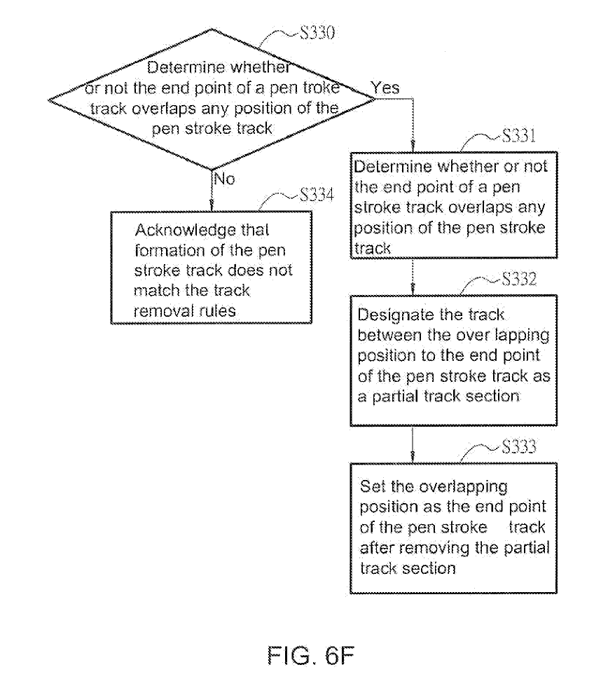

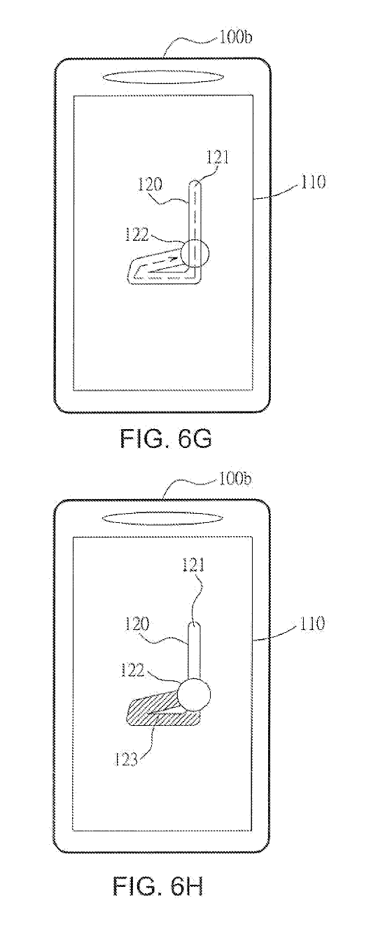

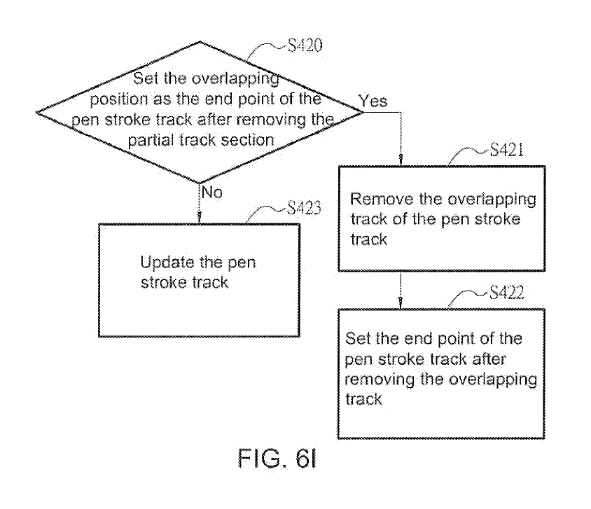

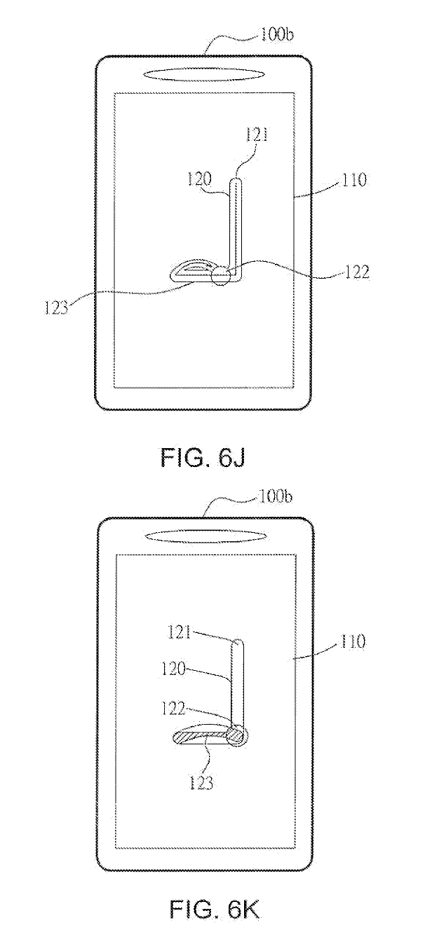

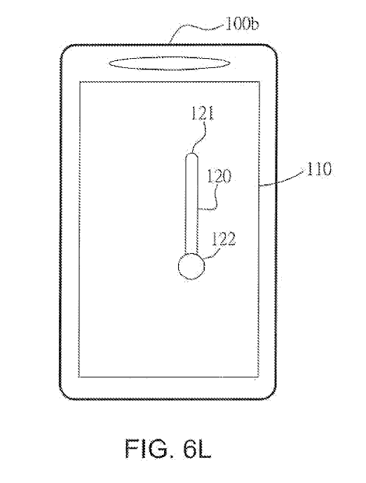

Referring to FIG. 6A, which shows a schematic flow chart of a second example for updating the pen stroke track according to the present disclosure, together with FIG. 5 and FIGS. 6B to 6L to facilitate understanding, in which FIG. 6B is a first track removal rule flow chart according to the second example of the present disclosure, FIG. 6C is a schematic view depicting a pen stroke track according to the second example of the present disclosure, FIG. 6D is a schematic view of error touch areas according to the second example of the present disclosure, FIG. 6E is a schematic view depicting partial track removal according to the second example of the present disclosure, FIG. 6F is a second track removal rule flow chart according to the second example of the present disclosure, FIG. 6G is a schematic view depicting track overlap according to the second example of the present disclosure, FIG. 6H is a schematic view depicting partial track removal according to the second example of the present disclosure, FIG. 6I is schematic flow chart of a third example for updating the pen stroke track according to the present disclosure, FIG. 6J is a schematic view depicting a pen stroke track according to the third example of the present disclosure, FIG. 6K is a schematic view depicting track overlap according to the third example of the present disclosure, and FIG. 6L is a schematic view depicting partial track removal according to the third example of the present disclosure. The pen stroke updating method comprises the following steps:

First, it is recorded the touched positions on the touch module 110 of the handheld touch control device 100b to continually form the pen stroke track 120 (step S210), this step being identical to step S110, and thus not detailed here.

Following step S210, the control unit 105 determines whether or not formation of the pen stroke track 120 matches the track removal rules 107 (step S220), the track removal rules 107 include three, and are described hereinafter:

The procedure for the first track removal rule is as depicted in FIG. 6B, and taking a down-left direction of the pen stroke track 120 as an example: error areas 130 for the pen stroke track 120 are first set, the error areas 130 being a specific width range of the two sides of the vertical pen stroke track 120 (step S310).

Then, as depicted in FIG. 6C, while continuing to produce the pen stroke track 120, the control unit 105 continues to set error areas 130 having a range of equal width on both sides of the pen stroke track with the pen stroke track 120 as center.

After which, it is determined whether or not the error areas 130 adjoining the end point 122 of the pen stroke track 120 have been touched (step S320). In the present example, the control unit 105 primarily takes touching of the error areas 130 at the end point 122 as the condition to determine whether or not the user wants to carry out a correction operation on the pen stroke track 120.

If it is determined that the peripheral error areas 130 at the end point 122 have been touched, it is acknowledged that formation of the pen stroke track 120 matches the track removal rules 107 (step S321), and the control unit 105 immediately analyzes the touched position of the error area 130 to calculate a partial track 123 of the pen stroke track 120 that needs to be removed (step S322). Position of the partial track 123 is depicted in FIG. 6D.

Referring to FIG. 6E, if the finger reverse slides from the end point 122 of the pen stroke track 120 in accordance with the formed pen stroke track 120, the reverse track produced being situated in the error areas 130, then the control unit 105 calculates that the error areas 130 have been touched, and successively designates the partial track 123 that needs to be removed.

If it is determined that the peripheral error areas 130 at the end point 122 have not yet been touched, it is acknowledged that formation of the pen stroke track 120 does not match the track removal rules 107 (step S323), whereupon the control unit 105 does not carry out any action.

The procedure for the second track removal rule is as depicted in FIG. 6F, in which the control unit 105 first determines whether or not the end point 122 of the pen stroke track 120 overlaps with any position of the pen stroke track 120 (step S330).

If an overlap is determined, it is determined that formation of the pen stroke track 120 matches the track removal rules 107 (step S331). As depicted in FIG. 6G, the end point 122 of the pen stroke track 120 is situated in and overlaps the vertical line section of the pen stroke track 120, thus, the pen stroke track 120 as drawn does not consequentially match the prestored track paths 111 of the storage module 106, and as depicted in FIG. 6H, the control unit 105 designates the track between the overlapping position to the end point 122 of the pen stroke track 120 as the partial track 123 (step S332), and subsequently sets the overlapping position as the end point 122 of the pen stroke track 120 after removing the partial track 123 (step S333). On the contrary, if it is determined that formation of the pen stroke track 120 does not match the track removal rules 107 (step S334), the control unit 105 does not carry out any action.

The procedure for the third track removal rule is as depicted in FIG. 6I and FIG. 6J, in which the touch module 110 records the touched positions to continually form the pen stroke track 120 of specific width. The end point 122 of the pen stroke track 120 is the current position on the touch module 110.

The control unit 105 determines whether or not the end point 122 of the pen stroke track 120 overlaps with adjoining tracks of the pen stroke track 120 (step S420). Step S420 primarily determines whether or not the finger is reverse sliding over the touch module 110 in accordance with the pen stroke track 120,

Referring to FIG. 6K, when it is determined that overlapping has occurred, the overlapping track of the pen stroke track 120 is removed (step S421). The majority of what is described as overlapping is partial overlapping. Because the positions touched by the finger reverse sliding over the touch module 110 in accordance with the pen stroke track 120 will consequentially be different from the positions touched on the touch module 110 by the previously drawn pen stroke track 120, thus, partial overlapping means is used to determine the partial track 123 that needs to be removed. After which, the end point of the pen stroke track 120 after removing the overlapping track is set (step S422), as depicted in FIG. 6L.

If it is determined that overlapping has not yet occurred, the control unit 105 confirms that there is no need to carry out removal of the pen stroke track 120, and the pen stroke track 120 continues to be updated (step S423).

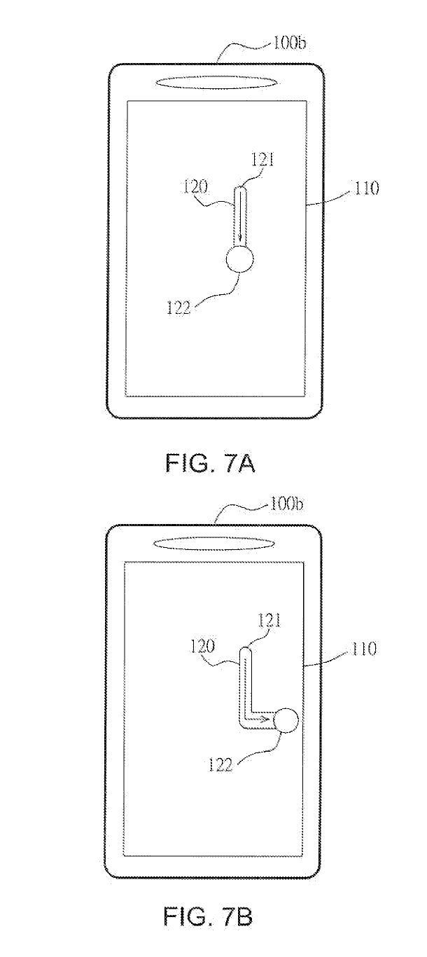

Referring to FIG. 7A and FIG. 7B, in which FIG. 7A is a schematic view depicting track retention according to the second example of the present disclosure, and FIG. 7B is a schematic view depicting pen stroke track updating according to the second example of the present disclosure.

As shown in FIG. 7A, regardless of which of the aforementioned track removal rules is used, so long as the control unit 105 determines formation of the pen stroke track 120 matches the track removal rules, then the partial track 123 of the pen stroke track 120 is removed according to the track removal rules 107 (step S221).

After which, the touch module 110 carries out an error correction on the current touched position and the end point 122 of the pen stroke track 120 (step S222). The step S222 is primarily directed at the pen stroke track 120 after removing the partial track 123, in which it is likely that the end point 122 of the pen stroke track 120 does not correspond with the current touched position on the touch module 110, thus, an error correction must be carried out on the distance between the end point 122 of the pen stroke track 120 and the current touched position on the touch module 110. On the contrary, if it is determined that formation of the pen stroke track 120 does not match the track removal rules, the pen stroke track 120 continues to be updated (step S223), and the control unit 105 determines whether or not the touch module 110 is still being touched (step S230).

If it is determined that the touch module 110 continues to be touched, the procedure returns to step 5210 to continually form the pen stroke track 120. Referring to FIG. 6D, FIG. 6G, FIG. 7A and FIG. 7B, the directions of the pen stroke track 120 are first down-left, after which the user reverse slides his finger on the touch module 110 to form an overlapping track, or enters the error areas 130. Then, the control unit 105 removes the partial track 123 produced according to the track removal rules 107, and finally, the user continues to slide his finger to form the pen stroke track 120 required by the user, such as a down-right track.

If it is determined that the touch module 110 is not being touched, thereby representing that the finger of the user has left the touch module 110, the current recorded pen stroke track 120 is taken as being what is required, and the handheld touch device 100b takes the recorded pen stroke track 120 as a stopped track, whereupon the stopped track is compared with the plurality of the track paths 111 of the handheld touch device 100b to obtain the track path 111 matching the stopped track 111 (step S240).

In addition, the handheld touch device 100b is able to execute the related control instruction according to the track path 111 matching the stopped track. The handheld touch device 100b is able to display the pen stroke track 120 matching the track path 111 on the touch module 110, and the pen stroke track 120 displayed on the touch module 110 is a line of specific width, description of which is the same as the above-mentioned, and thus not detailed here.

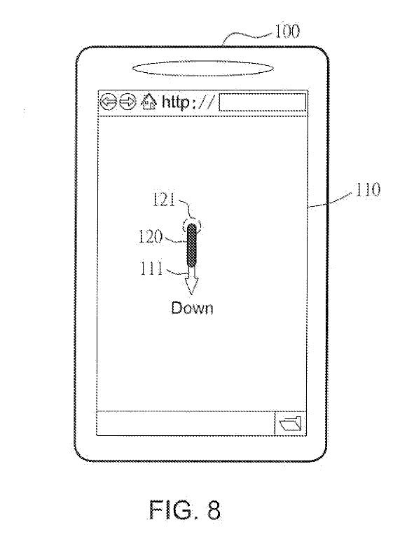

Referring to FIG. 8, which depicts a matching view of a pen stroke track and track path according to an example of the present disclosure, and referring together with FIG. 3E to facilitate reference thereto, in the aforementioned various pen stroke track updating methods, when the handheld touch device 100b determines that the touch module 110 is being touched, the touch module 110 displays the current executable control instruction track path.

As depicted in FIG. 8, when the handheld touch device 100b determines that the touch module 110 is still being touched, and is continually updating the pen stroke track (that is, step S132, step S223 or step S423), the track paths not matching the updated pen stroke track are removed from all the displayed track paths 111, and only the track paths 111 matching the updated pen stroke track 120 are retained.

It is of course to be understood that the examples described herein are merely illustrative of the principles of the disclosure and that a wide variety of modifications thereto may be effected by persons skilled in the art without departing from the spirit and scope of the disclosure as set forth in the following claims.

What is claimed is:

1. A method of inputting a control instruction of a handheld device, applicable to activate a program required by a user without opening function menus, comprising steps of: A pen stroke track updating method for handheld touch device, comprising the following steps:
recording touched positions on a touch module of a handheld touch device to continually form a pen stroke track;
matching the pen stroke track with a plurality of track paths prestored in the handheld touch device;
determining whether or not the pen stroke track matches at least one of the track paths;
removing the pen stroke track when a match is not determined;
updating the pen stroke track when a match is determined;
determining whether or not the touch module is still being touched; and
when it is determined that the touch module is still being touched, returning to the recorded touched position on the touch module of the handheld touch device to continue the step of forming the pen stroke track.

2. The pen stroke track updating method for handheld touch device according to claim 1, wherein the step of recording the touched positions on the touch module of the handheld touch device comprises the following step:
displaying the track paths while the touch module is being touched.

3. The pen stroke track updating method for handheld touch device according to claim 2, wherein the step of updating the pen stroke track comprises removing at least one of the track paths displayed on the touch module not matching the pen stroke track.

4. The pen stroke track updating method for handheld touch device according to claim 1, further comprising the following step:
recording the pen stroke track as a stopped track when it is determined that the touch module is not being touched, comparing the stopped track with the track paths, and obtaining the track path matching the stopped track.

5. The pen stroke track updating method for handheld touch device according to claim 4, further comprising
executing a control instruction according to the track path matching the stopped track.

6. A pen stroke track updating method for handheld touch device, comprising the following steps:
recording touched positions on a touch module of a handheld touch device to continually form a pen stroke track;
determining whether or not formation of the pen stroke track matches track removal rules;
when a match with the track removal rules is determined, removing a partial track of the pen stroke track according to the track removal rules, and carrying out an error correction on the current touched position and the end point of the pen stroke track of the touch module;
updating the pen stroke track when no match with the track removal rules is determined;
determining whether or not the touch module is still being touched; and
when it is determined that the touch module is still being touched, returning to the recorded touched position on the touch module of the handheld touch device to continue the step of forming the pen stroke track.

7. The pen stroke track updating method for handheld touch device according to claim 6, wherein the step determining whether or not formation of the pen stroke track matches track removal rules comprises the following steps:
setting error areas for the pen stroke track, the error areas being a specific width range of the two sides of the vertical pen stroke track;
determining whether or not the error areas adjoining the end point of the pen stroke track have been touched;
if it is determined that the error area adjoining the end point of the pen stroke track has been touched, acknowledging that formation of the pen stroke track matches the track removal rules, and analyzing the touched position of the error area to calculate a partial track of the pen stroke track that needs to be removed; and
if it is determined that the error areas adjoining the end point of the pen stroke track have not been touched, acknowledging that formation of the pen stroke track does not match the track removal rules.

8. The pen stroke track updating method for handheld touch device according to claim 6, wherein the step of determining whether or not formation of the pen stroke track matches the track removal rules comprises the following steps:
determining whether or not the end point of the pen stroke track overlaps any position of the pen stroke track;
if an overlap is determined, acknowledging that formation of the pen stroke track matches the track removal rules, designating the track between the overlapping position to the end point of the pen stroke track as the partial track, and setting the overlapping position as the end point of the pen stroke track after removing the partial track; and
if no overlap is determined, acknowledging that formation of the pen stroke track does not match the track removal rules.

9. The pen stroke track updating method for handheld touch device according to claim 6, wherein the step of determining whether or not formation of the pen stroke track matches the track removal rules comprises the following steps:
determining whether or not the end point of the pen stroke track overlaps adjoining tracks of the pen stroke track;
removing the overlapping track of the pen stroke track when an overlap is determined, and setting the end point of the pen stroke track after removing the overlapping track;
updating the pen stroke track when no overlap is determined;
determining whether or not the touch module is still being touched; and
when it is determined that the touch module is still being touched, returning to the recorded touched position on the touch module of the handheld touch device to continue the step of forming the pen stroke track.

10. The pen stroke track updating method for handheld touch device according to claim 6, wherein the step of determining whether or not the touch module is still being touched comprises the following step:
recording the pen stroke track as a stopped track when it is determined that the touch module is not being touched, comparing the stopped track with the track paths, and obtaining the track path matching the stopped track.

11. The pen stroke track updating method for handheld touch device according to claim 10, further comprising executing a control instruction according to the track path matching the stopped track.

12. The pen stroke track updating method for handheld touch device according to claim 6, wherein the step of recording touched positions on a touch module of a handheld touch device comprises the following steps:
when the touch module is being touched, displaying the track paths using a display module of the handheld touch device.

13. The pen stroke track updating method for handheld touch device according to claim 12, wherein the step of updating the pen stroke track comprises removing at least one of the track paths displayed on the display module not matching the pen stroke track.

14. A pen stroke track updating system for handheld touch device, comprising:
a storage module, the storage module is used to store a plurality of track paths;
a touch module, the touch module is used to enable touching and recording touched positions to continually form a pen stroke track; and
a control unit, the control unit is used to determine whether or not the pen stroke track matches at least one of the track paths, and when a match is determined, instructs the touch module to continue updating the pen stroke track, when no match is determined, the pen stroke track is removed, and when it is determined that the touch module is still being touched, the pen stroke track continues to be formed.

15. The pen stroke track updating system for handheld touch device according to claim 14, wherein the control unit instructs the touch module to display the track paths matching the pen stroke track.

16. The pen stroke track updating system for handheld touch device according to claim 14, wherein the control unit instructs the touch module to display the track paths while the touch module is being touched.

17. A pen stroke track updating system for handheld touch device, comprising:
a storage module, the storage module is used to store track removal rules;
a touch module, the touch module is used to enable touching and recording touched positions to continually form a pen stroke track; and
a control unit, the control unit is used to determine whether or not formation of the pen stroke track matches the track removal rules, and when a match is determined,
a partial track of the pen stroke track is removed according to the track removal rules, an error correction is carried out on the current touched position and the end point of the pen stroke track on the touch module; when a match is not determined, the pen stroke track is updated, and the pen stroke track continues to be formed when it is determined that the touch module is still being touched.

18. The pen stroke track updating system for handheld touch device according to claim 17, wherein the storage module stores a plurality of track paths, and the control unit instructs the touch module to display the track paths matching the pen stroke track.

19. The pen stroke track updating system for handheld touch device according to claim 17, wherein the storage module stores a plurality of the track paths, and the control unit instructs the touch module to display the track paths.

20. The pen stroke track updating system for handheld touch device according to claim 17, wherein the path track removal rules comprise designating a specific width range of the two sides of the vertical pen stroke track as error areas of the pen stroke track, when the control unit determines that the error area adjoining the end point of the pen stroke track has been touched, formation of the pen stroke track matches the track removal rules, and the control unit analyzes the touched position of the error area to calculate a partial track of the pen stroke track that needs to be removed.

21. The pen stroke track updating system for handheld touch device according to claim 17, wherein the track removal rules comprise: when the end point of the pen stroke track overlaps any position of the pen stroke track, formation of the pen stroke track matches the track removal rules, and the control unit designates the track between the overlapping position to the end point of the pen stroke track as a partial track, and the overlapping position is set as the end point of the pen stroke track after removing the partial track.

22. The pen stroke track updating system for handheld touch device according to claim 17, wherein the path removal rules comprise: when the end point of the pen stroke track overlaps the pen stroke track, the control unit removes the overlapping track of the pen stroke track, and sets the end point of the pen stroke track after removing the overlapping track.
